(19) United States
(12) Patent Application Publication
(10) Pub. No.: US 2026/0064937 A1
(43) Pub. Date: Mar. 5, 2026

(54) TEXT GENERATION METHODS AND APPARATUSES, STORAGE MEDIUM DEVICES, AND PROGRAM PRODUCTS

(71) Applicant: Alipay (Hangzhou) Information Technology Co., Ltd., Hangzhou (CN)

(72) Inventors: Changxu Shao, Hangzhou (CN); Yuhong Guo, Hangzhou (CN); Junping Zhao, Hangzhou (CN)

(73) Assignee: Alipay (Hangzhou) Information Technology Co., Ltd., Hangzhou (CN)

(21) Appl. No.: 18/958,985

(22) Filed: Nov. 25, 2024

(30) Foreign Application Priority Data
Aug. 27, 2024 (CN) 202411191242.3

(51) Int. Cl. G06F 40/126; G06F 16/334

(52) U.S. Cl. CPC G06F 40/126; G06F 16/3344

(57) ABSTRACT

This specification provides text generation methods, apparatuses, and storage medium devices. One method includes the following operations. In an iteration of a plurality of iterations under a large language model (LLM): estimating a first text sequence following a current text sequence based on a speculative decoding method, forming a plurality of candidate sequences based on the current text sequence and subsequences of the first text sequence, allocating logical blocks to text units in the plurality of candidate sequences in a key-value cache, to store attention information of the text units, mapping the allocated logical blocks to physical blocks based on a first criterion, and determining, by the LLM, a newly generated text unit in the iteration by using attention information of each candidate sequence in the key-value cache, to form a current text sequence for a next iteration of the plurality of iterations.

### CROSS-REFERENCE TO RELATED APPLICATIONS

This application claims priority to Chinese Patent Application No. 202411191242.3, filed on Aug. 27, 2024, which is hereby incorporated by reference in its entirety.

### TECHNICAL FIELD

One or more embodiments of this specification relate to the field of computer applications, and in particular, to text generation methods and apparatuses, storage medium devices, and program products.

### BACKGROUND

A large language model (LLM) is a deep learning model trained based on massive text data. The large language model can understand the meanings of texts, generate natural language texts based on given texts, and process various natural language tasks, for example, text summarization, question answering, and translation.

However, in the conventional technology, a process of generating natural language texts by the LLM through inference is slow, and an overall throughput of the LLM is relatively low.

### SUMMARY

In view of this, one or more embodiments of this specification provide text generation methods and apparatuses, storage medium devices, and program products.

According to a first aspect of one or more embodiments of this specification, a text generation method is provided, is applied to a large language model (LLM), and includes generating an output text for an input text by performing a plurality of rounds of iteration, where at least one round of iteration includes: estimating a first text sequence following an obtained current text sequence based on a speculative decoding method, and forming a plurality of candidate sequences based on the current text sequence and different subsequences of the first text sequence; allocating logical blocks to text units in the plurality of candidate sequences in a key-value cache, to store attention information of the text units, and mapping the allocated logical blocks to physical blocks based on a first criterion, where the first criterion includes that a plurality of logical blocks allocated to the same text unit in the plurality of candidate sequences are mapped to the same physical block; and determining, by the LLM, a newly generated text unit in the current round of iteration by using attention information of each candidate sequence in the key-value cache, to form a current text sequence for a next round.

According to a second aspect of one or more embodiments of this specification, a text generation apparatus is provided, is applied to an LLM, and generates an output text for an input text by performing a plurality of rounds of iteration, where at least one round of iteration is performed by the following units: a speculative decoding unit, configured to estimate a first text sequence following an obtained current text sequence based on a speculative decoding method, and form a plurality of candidate sequences based on the current text sequence and different subsequences of the first text sequence; a storage space allocation unit, configured to allocate logical blocks to text units in the plurality of candidate sequences in a key-value cache, to store attention information of the text units, and map the allocated logical blocks to physical blocks based on a first criterion, where the first criterion includes that a plurality of logical blocks allocated to the same text unit in the plurality of candidate sequences are mapped to the same physical block; and an LLM inference unit, used by the LLM to determine a newly generated text unit in the current round of iteration by using attention information of each candidate sequence in the key-value cache, to form a current text sequence for a next round.

According to a third aspect of the embodiments of this specification, a computer-readable storage medium is provided. The computer-readable storage medium stores computer instructions, and when the computer instructions are executed by a processor, the text generation method according to the first aspect of the embodiments of this specification is implemented.

According to a fourth aspect of the embodiments of this specification, a computer device is provided. The computer device includes: a processor; and a storage, configured to store instructions executable by the processor.

The processor runs the executable instructions to implement the text generation method according to the first aspect of the embodiments of this specification.

According to a fifth aspect of the embodiments of this specification, a computer program product is provided. When the computer program product is executed by a processor, the text generation method according to the first aspect of the embodiments of this specification is implemented.

This specification provides a text generation method and apparatus, a storage medium device, and a program product, which are applied to an LLM. In each round of iteration of the LLM, the following operations can be performed: A first text sequence following a current text sequence is obtained by using a speculative decoding method, and a plurality of candidate sequences are formed. Logical blocks are allocated to text units in the plurality of candidate sequences in a key-value cache, and the logical blocks are mapped to physical blocks. In a process of mapping to a physical block, mapping is performed based on a first criterion. Specifically, a plurality of logical blocks allocated to the same text unit in the plurality of candidate sequences obtained through speculative decoding are mapped to the same physical block. Then, a newly generated text unit in the current round of iteration is determined by the LLM by using attention information stored in the key-value cache.

In the above-mentioned method, first, the speculative decoding method is used, so that a quantity of tokens generated in one round of iteration is increased, and a quantity of rounds of iteration is decreased, to accelerate an inference process of the LLM. Then, a paging management method is used, so that more batches can be stored in the KV cache, and a quantity of requests that can be simultaneously processed by the LLM is increased, to increase an overall system throughput.

In addition, in the method provided in this specification, when speculative decoding is combined with paging management, in a special scenario in which there is the same text unit in a plurality of candidate sequences, the first criterion for mapping a logical block to a physical block is provided, so that the plurality of candidate sequences can occupy as little graphics memory space as possible, to further improve utilization of the graphics memory space.

Furthermore, based on use of the speculative decoding method in the above-mentioned method, in a process of generating an output text, a parallel computation amount in one round of iteration is increased, and a quantity of rounds of iteration is decreased. As such, a compute-to-memory access ratio is increased, and a hardware parallel capability can still be fully used in online scenarios with limited network traffic, thereby improving hardware resource utilization.

It should be understood that the above-mentioned general descriptions and the following detailed descriptions are merely examples and explanations, and should not limit this specification.

### BRIEF DESCRIPTION OF DRAWINGS

The accompanying drawings here are incorporated into this specification, constitute a part of this specification, illustrate embodiments that conform to this specification, and are used together with this specification to explain the principles of this specification.

FIG. 1 is a schematic diagram illustrating a key-value cache in the conventional technology, according to this specification;

FIG. 2 is a flowchart illustrating a text generation method, according to some example embodiments of this specification;

FIG. 3 is a partial schematic diagram illustrating a text generation method, according to this specification;

FIG. 4 is another partial schematic diagram illustrating a text generation method, according to this specification;

FIG. 5 is a flowchart illustrating a text generation method, according to some specific embodiments of this specification;

FIG. 6 is a block diagram illustrating a text generation apparatus, according to some example embodiments of this specification; and

FIG. 7 is a diagram illustrating a hardware structure of a computer device, according to some example embodiments of this specification.

### DESCRIPTION OF EMBODIMENTS

Example embodiments are described in detail here, and examples of the example embodiments are presented in the accompanying drawings. When the following descriptions are associated with the accompanying drawings, unless specified otherwise, the same numbers in different accompanying drawings represent the same or similar elements. Implementations described in the following example embodiments do not represent all implementations consistent with one or more embodiments of this specification, On the contrary, the implementations are merely examples of apparatuses and methods that are described in the appended claims in detail and consistent with some aspects of one or more embodiments of this specification.

It is worthwhile to note that the steps of the corresponding methods are not necessarily performed in the sequence shown and described in this specification in other embodiments. In some other embodiments, the method can include more or fewer steps than those described in this specification. In addition, a single step described in this specification may be split into a plurality of steps in other embodiments for description; and a plurality of steps described in this specification may be combined into a single step in other embodiments for description.

An LLM is a neural network model that can obtain an output text based on a user input text. The user input text can be a question to be answered, a text whose summary needs to be generated, a text that needs to be translated, etc. Tasks such as question answering, generation of a text summary, and text translation can be implemented by using the LLM.

A process in which the LLM generates an output text based on an input text is usually as follows: First, the input text is converted into a form that can be processed by the LLM, that is, converted into a text unit (Token) sequence. Then, inference is performed, that is, the token sequence of the input text is input to the LLM, encoding representation is performed on the token sequence, and an output token sequence is predicted based on the encoding representation. Finally, the output token sequence is converted into a text form to obtain the output text. A token is a smallest text unit processed by the LLM model, for example, a word or a character combination (root) in English, a single character in Chinese, etc.

There are the following problems in an inference process of the LLM model in the related technology:

### 1. Slow Inference Process

In the above-mentioned inference process of obtaining the output text, a current token to be output needs to be inferred by using previous information. Therefore, there is sequential dependency between generated tokens, and serial decoding needs to be performed. That is, a plurality of rounds of iteration need to be performed in the process of generating the output text, and in each round of iteration, the LLM needs to generate a next token of the output text by using a generated token and a token corresponding to the input text. This results in a relatively slow inference process of the LLM.

### 2. Relatively Low System Throughput

In a processing process of the LLM, an attention mechanism needs to be used to perform encoding representation on the token with reference to context. Therefore, information encoded can be referred to as attention information. In each round of iteration, the next token is generated by using the generated token of the output text and the token corresponding to the input text. In this case, attention information used in each round of iteration includes all attention information used in a previous round of iteration. Therefore, to reduce a computation amount of attention information, a key-value cache (KV cache) is stored in a graphics memory, and the key-value cache stores attention information of a token used in the process of generating the output text. As such, a computation amount in an iteration process can be reduced to accelerate inference.

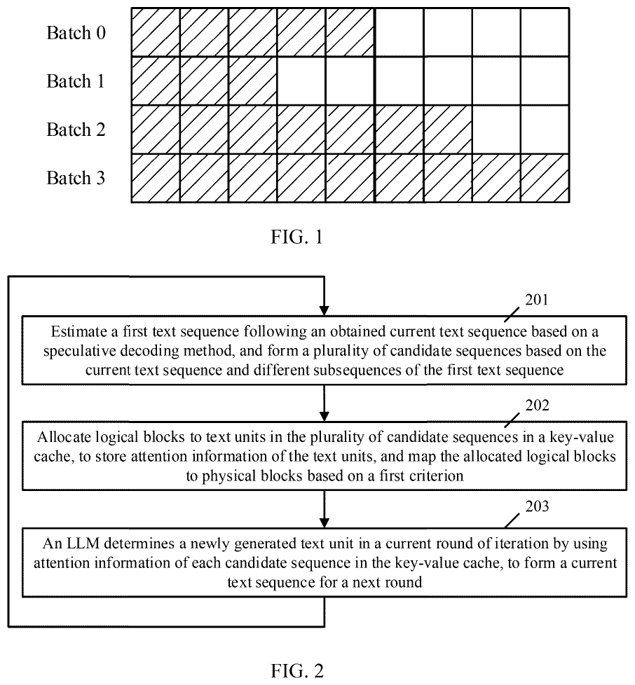

For case of understanding, a concept of request in the processing process of the LLM is described here. In one round of iteration, the LLM can simultaneously process a plurality of requests. Each request corresponds to one input text (usually from a user), and different requests correspond to different input texts. In one round of iteration, the LLM can generate a token subsequent to a text in a request. One batch in FIG. 1 corresponds to one request.

For a specific manner of storing the attention information in the KV cache in the related technology, references can be made to FIG. 1. Storage space in the KV cache is divided into a plurality of blocks based on rows and columns. Each row is used to store one batch, and one batch corresponds to one request. For requests of the same input text in different rounds of iteration, attention information needed for the requests in different rounds of iteration is usually stored by using a same batch.

Because lengths of output texts for requests are different, lengths of different batches are different. When lengths of different batches are different, a space size of the KV cache is directly proportional to a quantity of batches and a longest sequence length (max_seq_len). That is, a quantity of batches that can be stored in the KV cache is limited by a longest batch. Specifically, although a length of each of batch 0, batch 1, and batch 2 is less than a size of nine blocks, because a length of batch 3 is nine blocks, nine blocks need to be allocated to each of batch 0, batch 1, and batch 2. Further, as shown in FIG. 1, a shaded part is KV cache space that is actually needed. Consequently, graphics memory space in a non-shaded part is wasted. If the batch with the longest sequence length is very long, graphics memory space of the same size as graphics memory space of the batch with the longest sequence length needs to be allocated to all batches. Consequently, a large amount of graphics memory space, for example, the non-shaded part in FIG. 1, is wasted. In addition, when the KV cache has a limited size, the quantity of batches cannot be set to be very large. Consequently, a quantity of requests that can be sequentially processed by a system during iteration is relatively small, and an overall throughput is relatively low.

In addition, it is worthwhile to further note that in the KV cache, storage is performed based on a method shown in FIG. 1 to facilitate computation in an inference process of the LLM. Specifically, when the attention information is used by the LLM, attention information of a plurality of requests needs to be formed into a form of a matrix, and attention information of different requests is stored in different rows in the matrix. The matrix in which attention information is stored is multiplied by a weight matrix, to obtain output information. Therefore, the above-mentioned matrix can be conveniently obtained when storage is performed based on the method shown in FIG. 1. If batch 0, batch 1, etc. are consecutively stored in FIG. 1, when the matrix in which attention information is stored is directly obtained based on the KV cache in FIG. 1, different batches cannot be distinguished, and an accurate result cannot be obtained.

To resolve the above-mentioned two problems, there are two solutions in the related technology. The two solutions in the related technology are separately described below.

### 1. Speculative Decoding-Based LLM Acceleration Method

A speculative decoding process is usually as follows: Autoregressive sampling is performed for a request by using a simplified language model, to continuously generate a plurality of tokens. Then, the plurality of generated tokens are combined with a generated token, and the plurality of tokens obtained through speculative decoding are verified by using the LLM large model. If it is considered, after verification, that the plurality of tokens are appropriate, a next round of iteration continues to be performed. If the plurality of tokens are inappropriate, the large model generates a new token and continues a next round of iteration.

Compared with a solution in which no speculative decoding is performed, this solution increases a quantity of tokens that can participate in computation in one round of iteration, decreases a quantity of rounds of iteration, accelerates the inference process of the LLM, and reduces a request latency.

However, this solution cannot resolve the problem of a low system throughput and a limited quantity of batches stored in the KV cache. Because a sequence length of the batch that can be stored in the KV cache and the quantity of batches are in a trade-off relationship, a quantity of batches that can be simultaneously processed is relatively small when the length of the batch may be increased by using the speculative decoding method, resulting in a still low system throughput.

### 2. Paging Management-Based LLM Library

In the related technology, a PagedAttention mechanism is used to resolve the problem of a low system throughput. Specifically, the KV cache is organized into blocks of a fixed size, which are similar to pages in a virtual memory. Logically, the blocks are stored based on the method shown in FIG. 1. When logical blocks are mapped to physical blocks, the logical blocks can be consecutively stored or stored in any idle physical blocks, and a mapping relationship between a logical block and a physical block is recorded by using a block table.

This method improves utilization of physical storage space, and reduces a waste of a graphics memory.

However, this method still does not implement acceleration of the inference process of the LLM, and a request latency is relatively high. In addition, due to a limitation of instantaneous network traffic in online scenarios, a quantity of requests arriving in the same time period is relatively small, and an advantage of the batch cannot be fully used.

It can be seen that the method in the related technology cannot simultaneously resolve the above-mentioned problems of slow inference of the LLM and a low system throughput caused due to a waste of the graphics memory.

Based on this, this specification provides text generation methods, which are applied to an LLM. In each round of iteration of the LLM, the following operations can be performed: A first text sequence following a current text sequence is obtained by using a speculative decoding method, and a plurality of candidate sequences are formed. Logical blocks are allocated to text units in the plurality of candidate sequences in a key-value cache, and the logical blocks are mapped to physical blocks. In a process of mapping to a physical block, mapping is performed based on a first criterion. Specifically, a plurality of logical blocks allocated to the same text unit in the plurality of candidate sequences obtained through speculative decoding are mapped to the same physical block. Then, a newly generated text unit in the current round of iteration is determined by the LLM by using attention information stored in the key-value cache.

In the above-mentioned method, first, the speculative decoding method is used, so that a quantity of tokens generated in one round of iteration is increased, and a quantity of rounds of iteration is decreased, to accelerate an inference process of the LLM. Then, a paging management method is used, so that more batches can be stored in the KV cache, and a quantity of requests that can be simultaneously processed by the LLM is increased, to increase an overall system throughput.

In addition, in a method that uses only speculative decoding, because of a limitation of the KV cache, a batch has a limited length when a quantity of batches is ensured. In this case, a quantity of tokens that can be obtained in one round of speculative decoding is relatively small. However, compared with the method, a combination of speculative decoding and a batch eliminates a limitation on the length of the batch. In this case, a larger quantity of tokens can be obtained through speculative decoding, and an overall throughput is increased. In addition, a quantity of rounds of iteration is further decreased, an inference process is accelerated, and an end-to-end latency is reduced.

In addition, the above-mentioned method is not just a direct combination of the paging management method and the speculative decoding method, but is improved based on the combination of the paging management method and the speculative decoding method. Specifically, the first criterion is provided in the method provided in this specification. The first criterion is provided for a demand that exists only in a scenario in which paging management is combined with speculative decoding. In a paging management scenario, if no speculative decoding is performed, there is no candidate sequence including a plurality of subsequences of the first text sequence. In this case, different requests are specific to different input texts, there is no same text unit in different requests, and further there is no demand for mapping logical blocks of the same text unit to the same physical block.

It can be seen from the above-mentioned analysis that in the method provided in this specification, when speculative decoding is combined with paging management, in a special scenario in which there is the same text unit in a plurality of candidate sequences, the first criterion for mapping a logical block to a physical block is provided, so that the plurality of candidate sequences can occupy as little graphics memory space as possible, to further improve utilization of the graphics memory space.

In addition, the above-mentioned method further increases a compute-to-memory access ratio.

Specifically, although the inference process of the LLM in the conventional technology is slow, the slow inference is not caused due to limited hardware resources, and even computing performance of the hardware resources is not fully used in the inference process. Specifically, due to a limitation of instantaneous network traffic, a quantity of output texts that can be computed by a server in one round of iteration is limited, and consequently a relatively small quantity of tokens participate in computation in one iteration process. In addition, in each iteration process, all weight parameters of the LLM model need to be transmitted from a storage unit to a computing unit. It can be seen that in one iteration process, a large amount of time is consumed in a memory access operation, and less time is used for computation. That is, the computing performance of the hardware resources is not fully used in computing a relatively small quantity of tokens in each round of iteration, but the memory access operation consumes a large amount of time.

Based on use of the speculative decoding method in the above-mentioned solution, in a process of generating an output text, a parallel computation amount in one round of iteration is increased, and a quantity of rounds of iteration is decreased. As such, a compute-to-memory access ratio is increased, and a hardware parallel capability can still be fully used in online scenarios with limited network traffic, thereby improving hardware resource utilization.

The text generation method provided in this specification is described below. FIG. 2 is a flowchart illustrating a text generation method, according to some example embodiments of this specification. The method is applied to an LLM. In the text generation method, an output text is generated for an input text by performing a plurality of rounds of iteration, where at least one round of iteration includes the following steps shown in FIG. 2.

Step 201: Estimate a first text sequence following an obtained current text sequence based on a speculative decoding method, and form a plurality of candidate sequences based on the current text sequence and different subsequences of the first text sequence.

Specifically, to increase an inference speed of the LLM, a plurality of text units following the current text sequence are estimated by using a method with simpler complexity, and these text units can form the first text sequence. Therefore, the plurality of candidate sequences can be formed to verify the accuracy of each text unit in the first text sequence.

Step 201 can be divided into two phases. The first phase is a phase in which speculative decoding is performed to obtain the first text sequence, and the second phase is a process in which the plurality of candidate sequences are formed based on a speculative decoding result.

The first phase is described below. Nouns involved in the first phase are first described.

The obtained current text sequence can include a token obtained by converting the user input text and a token corresponding to the output text generated by using the LLM, or can include only a token sequence of the input text when the first output token is not generated for the input text, or can include only a generated token of the output text when the output token is generated.

The obtained current text sequence can correspond to one request, and one request is a request used to process one user input text in one round of iteration. For convenience of description, in this specification, requests are classified into an encoding request and a decoding request. The encoding request is a request for generating the first token of the output text, and the decoding request is a request for generating a token other than the first token of the output text.

Correspondingly, when a currently processed request is an encoding request, the obtained current text sequence can include the token obtained by converting the input text. When a currently processed request is a decoding request, the obtained current text sequence can include the token obtained by converting the input text and the token corresponding to the output text generated by using the LLM.

In addition, a processing process of one request is described in the above-mentioned explanations. In an inference process of the LLM, only one request can be processed at a time, or a plurality of requests can be simultaneously processed in one round of iteration. That is, the input text can alternatively include a plurality of user request texts. Correspondingly, the current text sequence includes several sequence segments, and each sequence segment corresponds to one request, and includes a user request text and an optional generated output text.

When the plurality of user request texts are simultaneously processed, the plurality of user candidate sequences are processed in parallel in the following step 202.

In some optional implementations, if a plurality of requests are simultaneously processed, speculative decoding can be performed only on a decoding request, no speculative decoding is performed on an encoding request, and only attention information of the encoding request is stored by using a KV cache. That is, the input text can include a plurality of user request texts. In this case, the current text sequence includes several sequence segments, and a single sequence segment corresponds to an output text generated for a single user request text (that is, the current text sequence includes a generated output text); and the first text sequence includes several continuation sequences respectively estimated for the several sequence segments.

Speculative decoding is performed only on the decoding request because for the encoding request, speculative decoding can increase an overall processing speed, but does not shorten a time to first token, and has limited acceleration impact on the encoding request. Therefore, speculative decoding is performed only on the decoding request, and no speculative decoding is performed on the encoding request, to ensure that the time to first token is not affected. As such, when a user has a demand on the time to first token, user experience can be ensured.

Certainly, when a plurality of requests are simultaneously processed, speculative decoding can be performed on both an encoding request and a decoding request. Implementations are not limited in this specification.

After the current text sequence is described, the first text sequence is described below. The first text sequence is a sequence including a text unit (Token), subsequent to the obtained current text sequence, obtained through speculative decoding. For example, if a text corresponding to the obtained current text sequence is “weather today”, a text corresponding to the first text sequence can be “is a sunny day”.

In addition, for one request, one result can be obtained through sampling, as described above, or a plurality of results can be obtained through sampling. When a plurality of results are obtained through sampling, the first text sequence can include a plurality of possible sequences subsequent to the current text sequence. For example, if a text corresponding to the current text sequence is “weather today”, a text corresponding to the first text sequence can be two possible results: “is a sunny day” and “is a cloudy day”.

There are advantages when one result is obtained through speculative decoding and there are advantages when a plurality of results are obtained through speculative decoding. When one result is obtained through speculative decoding, a subsequent computation amount of the LLM can be reduced, and repeated writing and return to the KV cache can be reduced. When a plurality of results are obtained through speculative decoding, accuracy of a result obtained through speculative decoding can be improved, thereby decreasing a quantity of rounds of iteration, and improving an LLM inference acceleration effect of speculative decoding.

Speculative decoding is described below.

Speculative decoding means that before a real generative operation is performed, a group of results are predicted by using an untrusted method, and then correctness of the predicted results is verified by using a trusted computational process. Generally, computational costs of the untrusted method are far less than computational costs of the trusted method.

An implementation of speculative decoding can be the same as the implementation in the related technology described above, that is, a plurality of tokens are obtained at a time by using a simplified language model. In addition, for the implementation of speculative decoding, speculative decoding can alternatively be implemented based on a vocab table. In a process of performing speculative decoding based on a vocab table, the current text sequence can be used as a key value, and a matching mapping value can be queried in the vocab table as the first text sequence. Certainly, the two speculative decoding examples shown in this specification do not represent limitations on this specification. Another speculative decoding method can alternatively be used in the method shown in this specification. Implementations are not limited in this specification.

A method for implementing speculative decoding based on a vocab table is described below in detail.

In some optional implementations, the vocab table can store a mapping relationship between the current text sequence and a text sequence subsequent to the current text sequence. By performing matching in the vocab table, a possible first text sequence subsequent to the current text sequence can be quickly obtained.

That is, a speculative decoding process can include querying a vocab table by using the current text sequence, to obtain the matching first text sequence. The vocab table includes a plurality of mapping relationships, the mapping relationship is a mapping relationship between a text sequence and a continuation text sequence following the text sequence, and the vocab table is obtained based on a text generated by the LLM.

The vocab table includes a mapping relationship, that is, includes a mapping relationship between a text sequence and a text sequence subsequent to the text sequence, for example, can store mapping relationships such as “weather tomorrow”-“is a sunny day” and “weather is”-“a sunny day”.

The mapping relationship in the vocab table can be obtained based on a text previously generated by the LLM model.

In addition, to improve a degree of matching between the output text and the input text, and improve the accuracy of the estimated first text sequence, the vocab table can include a global vocab table and a local vocab table. The global vocab table caches all high-frequency mapping relationships generated since a service is started, while the local vocab table caches a high-frequency mapping relationship generated in a process of generating an output text for a certain input text.

That is, the vocab table includes a global vocab table and a local vocab table; the global vocab table records a mapping relationship in which a co-occurrence frequency of sequences in the text generated by the LLM is greater than a first frequency threshold; the local vocab table records a mapping relationship in which a co-occurrence frequency of sequences in a text generated for the input text is greater than a second frequency threshold; and after the output text is generated, the local vocab table is added to the global vocab table.

The co-occurrence frequency is a frequency at which two sequences in the mapping relationship simultaneously and continuously occur in a corpus. The first frequency threshold and the second frequency threshold can be the same or different, and a specific value can be selected based on scenario needs.

After the output text is generated, the local vocab table can be added to the global vocab table because the text related to the corresponding input text does not need to be generated again.

By adding the local vocab table, some mapping relationships that are not common in other output texts but are relatively common in a scenario of the current input text, to improve accuracy of a matching result.

In addition, matching can be preferentially performed in the local vocab table when matching is performed, to improve a degree of matching between the matching result and the current scenario. Alternatively, matching can be performed in both the two vocab tables, to improve a degree of matching between the matching result and the current scenario and improve richness of a result.

In addition to storing the mapping relationship, the vocab table can further store a score value of the mapping relationship. The score value can be positively correlated with the co-occurrence frequency. When speculative decoding is performed, if a plurality of text sequences match the current text sequence, a text sequence with the highest score value can be used as the first text sequence. As such, the accuracy of the speculative decoding result can be improved, a quantity of tokens participating in computation in the LLM can be decreased, and the inference process of the LLM can be accelerated to some extent.

That is, the mapping relationship in the vocab table corresponds to a score value determined based on the co-occurrence frequency; and the querying a vocab table by using the current text sequence, to obtain the matching first text sequence includes: performing query and matching for the current text sequence in the vocab table; and when there are a plurality of matching text sequences in the vocab table, determining a text sequence with the highest score value as the first text sequence.

In addition, when there is a score value, to improve accuracy of speculative decoding, a score value of a mapping relationship that is not hit within a time period in the global vocab table can be reduced, and a reduction value can be determined based on a change value of the co-occurrence frequency.

In some other optional implementations, the vocab table can store a plurality of sentences, and the plurality of sentences can be sentences generated by the LLM. When the first text sequence is obtained, the current text sequence can be matched with the plurality of sentences. When there is a text, that matches the current text sequence, in a certain sentence in the vocab table, a text sequence subsequent to the current text sequence in the sentence can be used as the first text sequence.

For example, the current text sequence is “weather tomorrow”, and the vocab table stores the sentence “weather tomorrow is a sunny day”. In a process of performing matching between the current text sequence and the vocab table, if it is determined that “weather tomorrow is a sunny day” matches “weather tomorrow”, a subsequent text sequence “is a sunny day” of “weather tomorrow” in the sentence can be used as the first text sequence.

It is worthwhile to note that for ease of understanding, the above-mentioned examples are examples of the mapping relationship, the text sentence, etc., and are provided in a form of a text. However, in an actual application process, the vocab table stores a token corresponding to a text. The current text sequence and the first text sequence also exist in a form of a token sequence. Similarly, a text mentioned below also exists in a form of a token. Details are omitted here for simplicity.

Some commonalities between the above-mentioned two vocab tables are described below.

When the LLM model corresponds to a relatively short service application time and a relatively small quantity of texts are generated, the vocab table can alternatively be obtained based on a text obtained from a network. In this case, when the service application time corresponding to the LLM model is increased and the LLM model generates sufficient texts to form a vocab table, the original vocab table obtained based on the text obtained from the network can be deleted, to ensure accuracy of the speculative decoding result. Certainly, to ensure diversity of the speculative decoding result, the vocab table obtained based on the text obtained from the network can alternatively be retained.

If the first text sequence that matches the current text sequence does not exist in the vocab table, speculative decoding can be additionally performed for the current text sequence by using another speculative decoding method. Alternatively, a token subsequent to the current text sequence can be directly obtained by using the LLM.

In addition, when query is performed in the vocab table, query can be performed by using all tokens of the current text sequence as a key value.

In some cases, the generated output text is relatively long. If query is performed by using all the tokens of the current text sequence as a key value, a matching failure may be caused.

Therefore, in addition to performing query by using all the tokens of the current text sequence as a key value, matching and query can be performed by using last several tokens (a quantity can be predetermined) of the current text sequence as a key value. For example, if the current text sequence is “weather tomorrow is”, matching and query can be performed by selecting “weather is” as a key value.

Further, when the vocab table stores a mapping relationship, considering that most characters can be represented by using a single token or two tokens, a single token or a token pair can be used as a key value of the vocab table. In this case, a token used to perform matching in the vocab table can include a last single token or a token pair of the current text sequence, and a key value of the mapping relationship in the vocab table correspondingly includes a single token or a token pair.

In addition, as described above, speculative decoding can be performed on the encoding request. For the encoding request, the current text sequence can be all tokens corresponding to the input text, or last several tokens corresponding to the input text.

In addition, when the LLM simultaneously processes a plurality of requests, speculative decoding can be separately performed on the plurality of requests in one round of iteration. Correspondingly, the current text sequence includes several sequence segments, and matching can be separately performed for each sequence segment in the vocab table. Several continuation sequences respectively obtained for the several sequence segments through speculative decoding can form the first text sequence.

After the first phase of step 201 is described, the second phase of step 201, that is, the process of forming the candidate sequence, is described below.

After the first text sequence is obtained, because the LLM model can output a subsequent token only based on an input token at a time, the first text sequence cannot be directly verified. Therefore, to help the LLM determine, in subsequent steps, whether each token in the first text sequence is accurate, the first text sequence and the current text sequence need to be organized into forms of candidate sequences. This process can also be referred to as request splitting.

A single candidate sequence in the plurality of candidate sequences includes the current text sequence, or includes the current text sequence and a subsequence extracted from the beginning of the first text sequence. That is, the subsequence is a consecutive subsequence in the first text sequence, and the subsequence includes several carlier tokens of a possible speculative decoding result in the first text sequence. In addition, different candidate sequences are different, and different candidate sequences are used to verify different tokens in the first text sequence.

For example, the current text sequence is “weather tomorrow”, and the first text sequence includes two sequence segments: “is a sunny day” and “is a cloudy day”. Correspondingly, the candidate sequences include “weather tomorrow”, “weather tomorrow is”, “weather tomorrow is a sunny”, “weather tomorrow is a sunny day”, “weather tomorrow is a cloudy”, and “weather tomorrow is a cloudy day”.

By inputting each candidate sequence to the LLM in subsequent steps, the LLM can output a token subsequent to each candidate sequence, and can output a plurality of tokens by comparing the token with a token at a corresponding location in the first text sequence.

Step 202: Allocate logical blocks to text units in the plurality of candidate sequences in a key-value cache, to store attention information of the text units, and map the allocated logical blocks to physical blocks based on a first criterion.

The first criterion includes that a plurality of logical blocks allocated to the same text unit in the plurality of candidate sequences are mapped to the same physical block.

Specifically, in step 202, a paging management idea is used, and a form in which a logical block is allocated in the key-value cache and then mapped to a physical block is used, to reduce a waste of the non-shaded storage space in FIG. 1. In addition, on this basis, for speculative decoding, a plurality of candidate sequences that include the same token are obtained. For a plurality of candidate sequences of one user request text in one round of iteration, although different logical blocks are allocated to attention information of the same token in the plurality of candidate sequences in a logical unit, these different logical blocks are mapped to the same physical block. As such, the attention information is quickly read by using the logical block, and occupation of physical storage space is reduced, so that more batches are stored in the KV cache, and an advantage of the batch is fully used, to increase an overall system throughput.

A specific implementation of step 202 is described below.

First, for a specific meaning, stored content, and a function of the KV cache, references can be made to the above-mentioned descriptions. Details are omitted here for simplicity. Storage methods of the logical block and the physical block in the KV cache are described below in detail.

The storage method of the logical block is similar to the storage method shown in FIG. 1. Each row is used to store attention information corresponding to one request, that is, attention information of one candidate sequence. The logical block is stored to facilitate construction of an attention matrix, and facilitate computation by the LLM in subsequent steps.

That is, logical storage space corresponding to the key-value cache forms a matrix, and a logical block in one row in the matrix is used to store a text unit in one candidate sequence. Correspondingly, a process of allocating logical blocks is: adding a new row to the matrix for each candidate sequence, and adding a logical block to the row for a text unit in the candidate sequence.

Specifically, when a logical block is allocated, a new row can be added to the KV cache, and the logical block is mapped based on a block size. For example, for the encoding request, a logical block can be allocated based on a length of a token corresponding to an input text; and for the decoding request, a corresponding quantity of logical blocks can be allocated based on a longest length obtained after speculative decoding.

For example, if a length of a request (that is, an encoding request) in an encoding phase is 5 and the block size is 2, a new row needs to be added to the KV cache, and three logical blocks need to be allocated to the request in the row. In addition, because the request is an encoding request, the KV cache does not store any attention information of the request before the request is input. Therefore, after the logical block is allocated, the three allocated logical blocks need to be mapped to physical blocks for storage.

For another example, if a request (that is, a decoding request) in a decoding phase is split to obtain three requests (corresponding to different candidate sequences), for any request obtained through splitting, a new row can be added to the logical storage space, and a corresponding logical block is allocated to the request in the row. If a length of the request is 8, when the block size is 2, four logical blocks need to be allocated to the request. In the four logical blocks, if attention information of two logical blocks is the same as attention information of the request before splitting, and the attention information of the request before splitting is computed and stored in the KV cache in a previous round of iteration, the two logical blocks can be mapped to a corresponding stored physical block. In the four logical blocks, if a token corresponding to one logical block overlaps a token in another request obtained through splitting, logical blocks corresponding to the same token in the two requests obtained through splitting can be mapped to the same physical block. If content stored in the last one remaining logical block is different from that in another request, the logical block can be directly mapped to a new physical block.

In addition, a plurality of blocks in the physical storage space can be consecutively stored, or can be stored in idle storage space based on a storage rule. As such, all physical storage space can be applied, so that more batches can be simultaneously processed, to increase the system throughput.

Step 203: The LLM determines a newly generated text unit in the current round of iteration by using attention information of each candidate sequence in the key-value cache, to form a current text sequence for a next round.

Specifically, the plurality of candidate sequences can be simultaneously processed by using the LLM, to obtain a plurality of tokens in one round of iteration, and construct a text sequence for a next round of iteration based on the token generated in the current round of iteration, until the output text is obtained.

Compared with that in the method in which no speculative decoding is used in the related technology, the LLM needs to process more requests in one round of iteration, that is, more candidate sequences. However, for the LLM, compared with computation of a small quantity of requests, computation of an appropriate quantity of requests by the LLM in one round of iteration does not result in an excessively high latency because of a hardware parallel capability. For example, a time consumed by the LLM to process five requests is roughly the same as a time consumed to process 50 requests, and compared with processing of the five requests, processing of the 50 requests does not result in a significant latency. As such, the hardware parallel capability can be fully used in step 203, thereby decreasing a quantity of rounds of iteration and accelerating the inference process of the LLM.

A specific form of the LLM is not limited in this specification. The method in this specification can be applied to any existing LLM.

In step 203, a subsequent token can be predicted for each candidate sequence by using the attention information stored in the key-value cache, and a newly generated token in the current round of iteration can be determined based on the token predicted by the LLM for each candidate sequence. As such, by using the speculative decoding result as an input, a token subsequent to the input can be predicted, so that a plurality of token are generated in one round of iteration.

That is, the determining a newly generated text unit in the current round of iteration includes: The LLM predicts a next text unit for each candidate sequence by using the attention information of each candidate sequence in the key-value cache, and sequentially forms a second text sequence for next text units respectively predicted for the plurality of candidate sequences; and compares the second text sequence with the first text sequence, and determines the newly generated text unit based on a comparison result.

For example, the candidate sequences include “weather tomorrow”, “weather tomorrow is”, “weather tomorrow is a sunny”, and “weather tomorrow is a sunny day”. In this case, for “weather tomorrow”, the LLM can generate a token corresponding to “is”, and the token can verify whether “is” in the first text sequence is accurate; for “weather tomorrow is”, the LLM can generate a token corresponding to “a sunny”; for “weather tomorrow is a sunny”, the LLM can generate a token corresponding to “day”; and for “weather tomorrow is a sunny day”, the LLM can generate a subsequent token, for example, a token corresponding to “please”. Correspondingly, the second text sequence is “is a sunny day. Please”.

The second text sequence is compared with the first text sequence. A matching token “is a sunny day” can be used as a token verified as “correct”. As such, an objective of generating a plurality of tokens in one round of iteration is achieved.

In addition, in a verification process of the LLM, there are some tokens with incorrect speculative decoding results, and in step 202, logical blocks and physical blocks are allocated to these tokens. If there are tokens with incorrect speculative decoding results, logical blocks and physical blocks occupied by these tokens need to be returned, to reduce unnecessary resource occupation.

For an earlier token in the first text sequence, if a speculative decoding result of the token is incorrect, a token, subsequent to the token, obtained through speculative decoding is also untrusted, and a logical block and a physical block allocated to the subsequent token also need to be returned.

In addition, for a token in the second text sequence, if the token is different from a token at a corresponding location in the first text sequence, it indicates that a speculative decoding result of the token at the corresponding location in the first text sequence is incorrect and there is an incorrect text unit, and can further indicate that a token subsequent to the token in the second text sequence is also untrusted. This is because the token subsequent to the token is generated by the LLM based on the speculative decoding result. When the speculative decoding result is incorrect, the token subsequent to the token in the second text sequence is also untrusted.

That is, the following operations further need to be performed: determining a first incorrect text unit based on the comparison result, where the first incorrect text unit is a text unit that exists in the first text sequence and does not exist at a corresponding location in the second text sequence; determining a text unit following the first incorrect text unit in the first text sequence as a second incorrect text unit; and for each incorrect text unit in the first incorrect text unit and the second incorrect text unit, returning a logical block and a physical block corresponding to attention information of the incorrect text unit in the key-value cache.

The first incorrect text unit is directly obtained by comparing the first text sequence with the second text sequence. The second incorrect text unit is a token subsequent to the first incorrect text unit in the first text sequence. The second incorrect text unit may be a text unit that exists at a corresponding location in each of the first text sequence and the second text sequence but is actually incorrectly estimated.

In addition, when the logical block is allocated, the plurality of candidate sequences occupy a plurality of rows. However, in the next round of iteration, the plurality of rows of candidate sequences in the current round of iteration are no longer needed. Therefore, after the newly generated text unit in the current round of iteration is determined, the plurality of candidate sequences in the logical block can be combined to facilitate the next round of iteration. Certainly, in the next round of iteration, when a logical block is allocated to a candidate sequence obtained through speculative decoding in the next round of iteration, the logical block occupied by the plurality of candidate sequences in the current round of iteration is processed together. Implementations are not limited in this specification.

How to combine the LLM batch with the speculative decoding method in the iteration process is described above. When to perform the above-mentioned method is described below.

It is found, in a process of testing this solution, that when no limitation is imposed on sampling behavior, compared with those in a case of not using this solution, a token generation speed (Token/s) and the throughput (qps) are increased by 12 times in a case of using this solution, but the corresponding time to first token is also doubled. It can be seen that although the above-mentioned method can increase the system throughput and an output speed of the output text, in the above-mentioned process, a computation amount in each round of iteration is increased, and a time needed for one round of iteration is longer than that in the related technology. This leads to an increase in the time to first token. The time to first token is a time consumed from sending of the input text by the user to the system to generation of the first token in the output text.

There are different demands on a system performance indicator in different scenarios. There may be a relatively high demand on the time to first token in some scenarios, there may be a relatively high demand on the system throughput in some scenarios, and there may be a relatively high demand on both the time to first token and the system throughput in some scenarios. Therefore, for different scenarios, three optional modes are provided in an example provided in this specification, to support more service scenarios by using a plurality of optional modes. The three optional modes are described below.

1. Speculative decoding is disabled.

Speculative decoding increases a computation amount in one round of iteration, and increases a data amount for LLM inference. In addition, a speculative decoding operation and KV cache allocation and reclaim cause additional overheads. Furthermore, speculative decoding cannot shorten a generation time of the first token. Therefore, if speculative decoding is used, the time to first token is adversely affected. However, if speculative decoding is disabled, adverse impact of speculative decoding on the time to first token is avoided. In scenarios in which there is a relatively high demand on the time to first token, this mode can be used to avoid an increase in the time to first token.

2. Speculative decoding is performed when all requests are decoding requests.

That is, when a plurality of requests are processed in one round of iteration, that is, the current text sequence includes a plurality of sequence segments, a process of estimating the first text sequence in the first phase of step 201 includes: performing the speculative decoding only when the LLM generates at least one output text unit for each of the plurality of user request texts, where the current text sequence includes a plurality of sequence segments corresponding to the plurality of user request texts.

When at least one output text unit is generated for each of the plurality of user request texts, it represents that a request corresponding to the sequence segment is a decoding request instead of a request for generating the first token.

This mode is applicable to applications or services with a relatively high demand on the time to first token, a relatively high demand on the end-to-end latency (that is, a latency for generating the complete output text), and a relatively high demand on the throughput. Considering that speculative decoding adversely affects the time to first token and has no acceleration effect on a request in the encoding phase, decoding sampling is performed only when a certain input is a decoding request, to balance a plurality of performance indicators, that is, the time to first token, the end-to-end latency, and the throughput.

3. Adaptive speculative decoding is performed based on a request length.

First, it is worthwhile to note that when a computing power indicator is evaluated below, the computing power indicator is evaluated based on a quantity of tokens whose attention information needs to be computed in one round of iteration. The computing power represents a maximum quantity of tokens that can be simultaneously processed by the system in one round of iteration without significantly affecting the processing speed. Processing here is processing of computing the attention information. For example, if the computing power is 100 tokens, it indicates that the system can compute attention information of a maximum of 100 tokens in parallel in one round of iteration without affecting the processing speed.

It is worthwhile to further note that this part is specific to scenarios in which a plurality of requests are processed in one round of iteration.

Specifically, when a relatively large quantity of requests are processed in one round of iteration or there is a very large quantity of tokens in an input encoding request, and when hardware performance can be fully used, speculative decoding can no longer be performed. Otherwise, a response speed may be decreased. For example, the hardware computing power indicator is 100 tokens, and the quantity of tokens in the input encoding request is 100 tokens or even greater than 100 tokens. In this case, there is no extra computing power to be allocated to the decoding request, and therefore speculative decoding may not be performed to avoid significantly affecting the processing speed.

When a relatively small quantity of requests are input or there is an insufficient quantity of tokens in an input encoding request, and hardware performance cannot be fully used, computing power consumed for the encoding request can be subtracted from the hardware computing power indicator, and the remaining computing power is equally allocated to a plurality of decoding requests, to determine a quantity of tokens obtained for each decoding request through speculative decoding, that is, a length of the first text sequence.

That is, before speculative decoding, the following operations further need to be performed: determining a hardware computing power indicator and a first quantity of text units in a target request text, where the hardware computing power indicator is used to represent a maximum quantity of text units whose attention information can be simultaneously computed, and the target request text is a user request text for which a first text unit in an output text is not generated when the current round of iteration starts; determining an available computing power indicator based on a difference between the maximum quantity of text units and the first quantity; and determining a length of the first text sequence based on the available computing power indicator.

The target request is an encoding request. By subtracting the quantity of the target request from the maximum quantity of text units, the available computing power indicator, that is, a computing power indicator available for the decoding request, is obtained. The available computing power indicator can be further allocated to a plurality of decoding requests based on a predetermined allocation criterion, to determine the length of the first text sequence. The predetermined allocation criterion can be equal allocation, etc.

For example, a hardware computing power indicator of a certain machine is that 100 tokens can be simultaneously processed, and there are only a total of 36 tokens in an input encoding request. In this case, it can be determined that the available computing power indicator is 64 tokens, and the computing power indicator of 64 tokens can be equally allocated to all decoding requests. If there are 16 decoding requests, three additional tokens need to be obtained through speculative decoding based on an input token for each decoding request.

In the above-mentioned example, a first text sequence obtained through speculative decoding for each decoding request includes three tokens instead of four tokens because for the request in the decoding phase, attention information of the first text sequence obtained through speculative decoding needs to be computed in one round of iteration, and a token whose attention information is not computed in a previous round of iteration further needs to be computed. Specifically, when the first text sequence estimated through speculative decoding is correct, in step 203, the LLM may further generate a subsequent token for a candidate sequence including the current text sequence and the first text sequence, and attention information of the token needs to be computed in the next round of iteration.

For example, if the current text sequence is “weather tomorrow”, and the first text sequence is “is a sunny day”, attention information of a token corresponding to “is a sunny day” is computed in the current round of iteration and stored in the KV cache in step 202. For the candidate sequence “weather tomorrow is a sunny day”, if the LLM further generates the token corresponding to “please” in step 203, attention information of the token corresponding to “please” is computed in the next round of iteration.

This mode is applicable to applications or services with a high demand on the end-to-end latency and a high demand on the throughput. In the above-mentioned mode, utilization of computing resources can be maximized, and a low end-to-end latency and a high throughput can be ensured as much as possible while the throughput is ensured.

In addition, the plurality of above-mentioned modes can be adjusted based on a performance indicator to which a service pays close attention, to obtain a shorter latency or a higher throughput. If there is no performance indicator to which close attention is paid, the system can adaptively adjust a sampling length, to ultimately obtain system performance with a relatively balanced latency and throughput.

TABLE 1

| | Sampling mode | |
|---|---|---|
| Performance indicator | Throughput | Time to first token |
| Speculative decoding is disabled | Poor | Good |
| Speculative decoding is performed | Medium | Medium |
| when all requests are decoding | | |
| requests | | |
| Adaptive speculative decoding is | Good | Medium |
| performed based on a request length | | |

For performance of the performance indicator in the three modes, references can be made to Table 1. It can be seen from Table 1 that when the speculative decoding method is disabled, a relatively good time to first token can be obtained, but an overall request latency and system throughput are relatively poor. If speculative decoding is performed when all requests input in one round of iteration are decoding requests, a slightly better time to first token can be obtained, and an overall system latency and throughput are slightly better than those obtained when sampling optimization is completely disabled. When adaptive speculative decoding is performed based on a quantity of requests, sequences of different lengths are obtained through sampling for batches in different rounds of iteration based on a quantity of tokens input in a current round of iteration. This can greatly increase the system throughput and shorten the request latency, but affects the indicator of the time to first token.

In conclusion, compared with the method in which a paging-based KV cache is simply used in the related technology, the method provided in this specification decreases a quantity of rounds of iteration in a text generation process through speculative decoding, and lowers the request/end-to-end latency. In addition, the method removes serial dependency, obtains the first text sequence through speculative decoding, and performs verification on the first text sequence by using the LLM. This increases a data amount in one time of computation, and fully uses a GPU parallel computing capability. As such, a problem that a hardware parallel capability cannot be fully used due to a limitation of instantaneous traffic in online scenarios is resolved, thereby increasing a service throughput.

Compared with that in the method in which only speculative decoding is used in the related technology, in this solution, paging-based graphics memory management is added. This process includes a logical block mapping process input after sampling and a graphics memory return process after a request ends. This greatly reduces graphics memory fragmentation, increases a quantity of tokens that can be obtained through sampling, and further increases the service throughput. In addition, this specification provides a plurality of sampling modes, and a user can flexibly select an appropriate sampling mode based on a service scenario, to obtain better service performance.

In addition, in the method provided in this specification, the speculative decoding method and the paging management method are not directly combined, but a problem that exists in a scenario after combination is resolved. In this system, KV cache space is managed by using the paging-based graphics memory management method, and the KV cache is divided into logical blocks that include specific sequence lengths for allocation. In addition, requests obtained through splitting due to speculative decoding can share KV cache space with a common prefix, that is, logical blocks corresponding to the same token in candidate sequences are mapped to the same physical block, to save a large amount of graphics memory space to carry more batch requests, and increase the service throughput.

The text generation method provided in this specification is described below by using a specific embodiment.

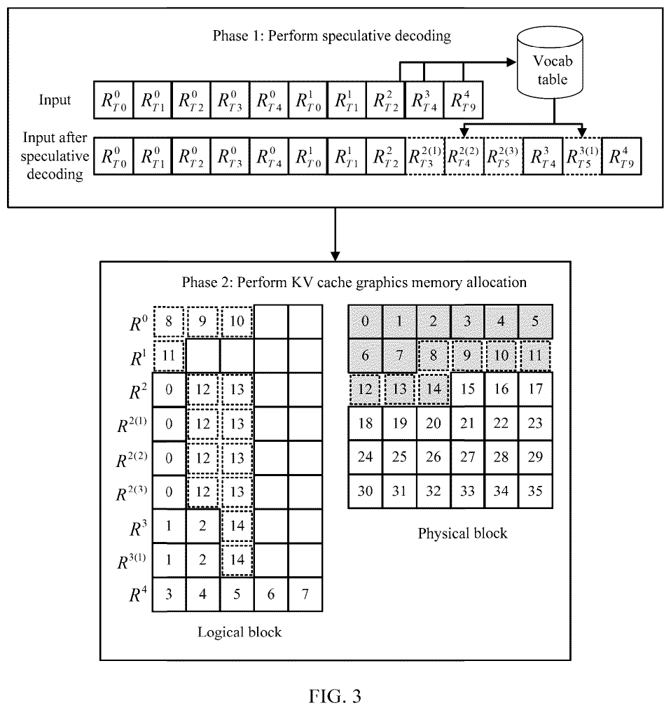

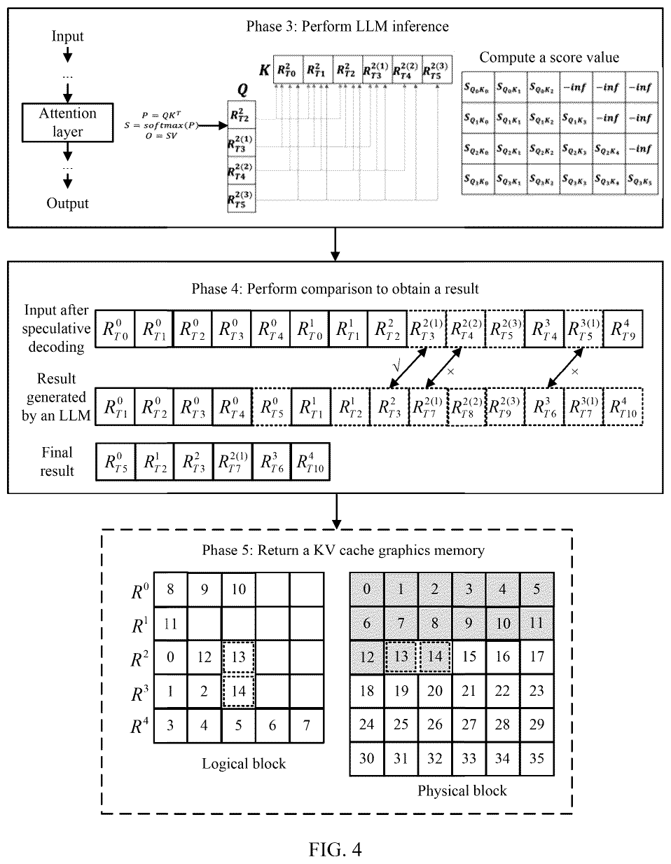

A service can obtain an input text, and generate an output text for the input text. The process can be implemented by performing a plurality of rounds of iteration. Each round of iteration can include five phases shown in FIG. 3 and FIG. 4. FIG. 3 and FIG. 4 jointly form the five phases in each round of iteration. For ease of reading, the five phases are described here by using two figures, that is, FIG. 3 and FIG. 4. It is easy to understand that after phase 2 in FIG. 3 in cach round of iteration ends, phase 3 shown in FIG. 4 needs to be performed.

The service includes a plurality of modules responsible for performing iteration. The modules are as follows:

First, a scheduling module is responsible for reading a related configuration, receives a new request, and determines whether the request ends.

Second, a KV cache management module is responsible for KV cache paging management, and mainly provides functions such as KV cache physical block allocation, reclaim, and logical block mapping.

Third, a lookahead module is responsible for speculative decoding, where a vocab table query-based sampling method is used in this specification, and mainly provides functions of storing a token sequence, performing sampling based on current token information, extracting a correctly sampled sequence, etc.

Fourth, a batcher module is mainly responsible for constructing a model input based on a request input and speculative decoding information, and constructing request output data based on a model output.

As shown in FIG. 3 and FIG. 4, in a process of generating a plurality of output texts for a plurality of input texts by the service, each round of iteration includes the following five phases.

First, before iteration starts, and before phase 1 in FIG. 3 is performed, the scheduling module first receives a new request, determines whether a request participating in iteration in a previous round ends, to select a request to participate in a current time of computation, determines, based on a predetermined mode, whether to perform speculative decoding, and when speculative decoding needs to be performed, continues to perform phases 1-5 shown in FIG. 3 and FIG. 4. If a speculative decoding module does not need to be performed, phase 1 is not performed, the batcher module directly constructs model input data, and phase 3 is performed to obtain a token output in the current round of iteration.

In addition, if a mode used is that adaptive speculative decoding is performed based on a request length, the scheduling module can further determine a length for speculative decoding.

In phase 1, speculative decoding is performed. This phase is performed by the lookahead module.

First, for ease of understanding, meanings of letters in FIG. 4 are described here. Here,

$${R}_{T j}^{i}$$

represents a j^{th} token in an i^{th} request,

$${R}_{T j}^{i ( k )}$$

represents a k^{th} token obtained for the i^{th} request through speculative decoding, k represents an index of the k^{th} token in a sequence segment of a first text sequence, and j represents an overall index of the k^{th} token in a current text sequence and the sequence segment corresponding to the first text sequence, that is, an overall index in tokens processed by an LLM for a certain request.

The input shown in FIG. 3 includes five requests, where request 0 and request 1 are encoding requests, and request 2, request 3, and request 4 are decoding requests. The input shown in FIG. 1 refers to a length of a sequence input to a vocab table. Therefore, tokens in request 0 and request 1 in an encoding phase are counted starting from 0. However, when speculative decoding is performed on a request in a decoding phase based on the vocab table, one token is used as a key value. Therefore, in the input request, each of request 2, request 3, and request 4 includes only the last token. For a token included in each request, references can be made to the descriptions in FIG. 3. Details are omitted here for simplicity.

Based on speculative decoding, from the vocab table, three tokens are obtained for request 2 through sampling, one token is obtained for request 3 through sampling, and matching of request 4 is not completed in the vocab table, and no token is obtained through sampling. In FIG. 3, the token obtained through speculative decoding is marked by using a dashed line.

Because a plurality of tokens are obtained for each of request 2 and request 3 through speculative decoding, each of request 2 and request 3 is correspondingly split into a plurality of requests.

Specifically, request 2 is split into four requests: R², R²⁽¹⁾, R²⁽²⁾, and R²⁽³⁾. A candidate sequence corresponding to R² includes a token

$${R}_{T 2}^{2} ;$$

a candidate sequence corresponding to R²⁽¹⁾ includes tokens

$${R}_{T 2}^{2} and {R}_{T 3}^{2 ( 1 )} ;$$

a candidate sequence corresponding to R²⁽²⁾ includes tokens

$${R}_{T 2}^{2} , {R}_{T 3}^{2 ( 1 )} , and {R}_{T 4}^{2 ( 2 )} ;$$

and a candidate sequence corresponding to R²⁽³⁾ includes tokens

$${R}_{T 2}^{2} , {R}_{T 3}^{2 ( 1 )} , {R}_{T 4}^{2 ( 2 )} , and {R}_{T 5}^{2 ( 3 )} .$$

In some implementations, each of the several requests can further include R_{T0}² and R_{T1}². Request 3 is similar to request 2. Details are omitted here for simplicity.

In phase 2, the plurality of requests obtained through splitting need to be respectively stored in different rows in a logical block. In phase 3, one token is separately generated for each request obtained through splitting.

In phase 2, KV cache graphics memory allocation is performed. This phase is performed by the KV cache management module.

First, the KV cache management module can first determine whether there are sufficient logical blocks, and if there are insufficient logical blocks to complete current mapping, can first allocate a physical memory, and then perform KV cache logical block mapping. If there are sufficient graphics memory blocks, logical block mapping is directly performed, and a physical block is allocated to the logical block.

There is no one-to-one correspondence between logical blocks and physical blocks. Therefore, even if there is no idle logical block in logical storage space, storage can continue to be performed in physical storage space. In this case, an attempt can be first made to allocate a physical block to attention information. If the physical block can be allocated, it indicates that a logical block can be added to the logical storage space. Otherwise, if a logical block is directly allocated, content corresponding to the logical block possibly cannot be stored in the physical storage space.

For each request, KV cache graphics memory allocation can be performed by using the method shown in FIG. 3. In FIG. 3, a logical block area on the left side shows the logical storage space including logical blocks, and a physical block on the right side shows the physical storage space. Physical blocks are exemplarily identified and distinguished by using numbers 0-35. A number in a logical block indicates that the logical block is mapped to a physical block represented by using the number. For example, the first logical block in the last row in the logical storage space is marked with a number 3, indicating that the logical block is mapped to physical block 3, that is, physical block 3 is used to store content in the logical block.

In a box corresponding to a logical block, a box shown by using a dashed line is a block to which a new physical block needs to be currently allocated, and a box shown by using a solid line is a block to which a physical block has been allocated. In a box corresponding to a physical block, a dashed line box is a physical block to which new mapping needs to be performed in a current round of iteration, a solid line box is a physical block to which mapping has been performed, and a box with a gray background is a physical block occupied after the current round of iteration. Different sizes of the dashed line box and the solid line box in FIG. 3 are for case of reading, and do not indicate a difference in an amount of content stored in the two types of blocks. Optionally, a block size can be 2.

Specifically, for request 0 and request 1 in the encoding phase, because the encoding requests participate in iteration for the first time, attention information of these requests is not previously stored in a KV cache. Therefore, a logical block needs to be allocated to the encoding request, and the logical block is mapped to a physical block, that is, physical blocks 8-11 are newly allocated and newly mapped.

For request 4, because no token is obtained through speculative decoding, there is no need to allocate a logical block and a physical block to the request in the current round of iteration.

For request 2 and request 3, a plurality of candidate sequences obtained after speculative decoding need to be first determined, then a new row is added to the logical space for each candidate sequence, and a logical block is mapped to a physical block. During mapping to a physical block, logical blocks corresponding to the same token need to be mapped to the same physical block.

For request 2, four requests are obtained through splitting, and each of the four requests occupies one row in the logical space for storage. Although respective first logical blocks in the four requests are newly allocated in the logical storage space to the requests obtained through splitting from request 2, the first logical blocks store attention information of

$${R}_{T 2}^{2}$$

and a previous token of

$${R}_{T 2}^{2} ,$$

and the attention information is computed in a previous round of iteration and stored in physical block 0. A continuation logical block stores attention information of the token obtained through speculative decoding. Therefore, a physical block (that is, block 12 and block 13) needs to be allocated to the logical block in the current round of iteration for storage.

A physical block allocation process of request 3 is similar to that of request 2. Details are omitted here for simplicity.

In phase 3, LLM inference is performed. The batcher module constructs model input data, and performs model inference. In a model inference process, attention information in the KV cache needs to be read.

As shown in FIG. 4, the LLM model inference process in phase 3 includes the following: Each request (including a request corresponding to the candidate sequence) is input to a neural network model, and one or more layers of the neural network model perform processing. For example, a normalization layer (LayerNorm) can first process input data. Then, processed data are input to an attention layer (Attention). A processing formula of the attention layer is shown in FIG. 4. In FIG. 4, request 2 is used as an example to compute attention information. Another request is similar to request 2. Details are omitted here for simplicity. After attention processing is completed, a series of processing, for example, normalization layer, can be further performed, to complete the LLM inference process.

In phase 4, comparison is performed to obtain a result.

Specifically, misaligned comparison is performed based on a predicted result of the LLM model and input data after sampling, to obtain the final result.

The input after speculative decoding shown in FIG. 4 is the current text sequence and the first text sequence mentioned in step 201, where a token in a solid line box is the current text sequence, and a token in a dashed line box is the first text sequence obtained through speculative decoding. A token in a dashed line box in a result generated by the LLM is a second text sequence generated by the LLM for the candidate sequence. The final result is a newly generated token in the current round of iteration.

The input after speculative decoding and the result generated by the LLM are shown in FIG. 4. The LLM generates a token

$${R}_{T 5}^{0}$$

for request 0; and generates a token

$${R}_{T 2}^{1}$$

for request 1; and the LLM generates

$${R}_{T 10}^{4}$$

for request 4. Because no token are obtained for these several requests through speculative decoding, these tokens do not need to be compared. These tokens can be directly used as final results corresponding to the three requests.

For the candidate sequence corresponding to request 2, a token

$${R}_{T 3}^{2}$$

is generated for the candidate sequence R². As shown in FIG. 4, after misaligned comparison is performed (that is, tokens at corresponding locations in the input after sampling and the generated result are compared based on a token sequence), it is determined that

$${R}_{T 3}^{2 ( 1 )}$$

generated in the first text sequence is accurate. A token

$${R}_{T 7}^{2 ( 1 )}$$

is generated for the request R²⁽¹⁾. It can be determined that

$${R}_{T 7}^{2 ( 1 )} and {R}_{T 4}^{2 ( 2 )}$$

are different, and therefore it is determined that

$${R}_{T 4}^{2 ( 2 )}$$

and a token following

$${R}_{T 4}^{2 ( 2 )}$$

in the first text sequence are inaccurate. Because it is determined that both

$${R}_{T 4}^{2 ( 2 )}$$

and the token following

$${R}_{T 4}^{2 ( 2 )}$$

are inaccurate, there is no need to perform misaligned comparison between the token following

$${R}_{T 4}^{2 ( 2 )}$$

and a token generated by the LLM. In addition, it can be determined that in the result generated by the LLM,

$${R}_{T 8}^{2 ( 2 )}$$

generated for R²⁽²⁾ and

$${R}_{T 9}^{2 ( 3 )}$$

generated for R²⁽³⁾ are inaccurate. Therefore, for request 2, newly generated tokens in the current round of iteration include

$${R}_{T 3}^{2} and {R}_{T 7}^{2 ( 1 )} .$$

For the candidate sequence corresponding to request 3, a misaligned comparison process is the same as that of request 2. Details are omitted here for simplicity.

After the final result is obtained, the final result can be used as an input in a next round of iteration, and speculative decoding is performed based on the final result in the next round of iteration.

In phase 5, a KV cache graphics memory is returned. This phase is performed by the KV cache management module.

As described above, it can be determined, through misaligned comparison in phase 4, that there is an inaccurate token in the first text sequence, and there is no need to continue to store attention information of the token. Therefore, a logical block and a physical block allocated to the token in phase 2 need to be returned.

Specifically, incorrect tokens in first text sequences corresponding to request 2 and request 3 are

$${R}_{T 4}^{2 ( 2 )} , {R}_{T 5}^{2 ( 3 )} , and {R}_{T 5}^{3 ( 1 )} .$$

Corresponaingly, storage space occupied by the incorrect tokens needs to be deleted. That is, there are logical blocks that need to be returned in requests 2 and 3. If blocks that need to be returned are 13 and 14, logical blocks and physical blocks corresponding to 13 and 14 need to be returned.

In addition, when the logical block and the physical block are returned, requests obtained through splitting can be further combined into one request, and a corresponding row in the logical block is deleted. For example, for a plurality of rows obtained by splitting request 2, only one row of candidate sequence R² can be retained.

As shown in FIG. 4, a logical block and a physical block that need to be returned are marked by using a dashed line box, and a physical block that has been mapped is marked by using a block with a gray background. It can be seen from FIG. 4 that blocks 13 and 14 need to be returned. In addition, to facilitate the next round of iteration, in the logical block, the plurality of requests obtained by splitting request 2 are combined into one request for storage. Similar processing is performed on request 3.

Phase 1 to phase 5 are iterated, so that an output text can be generated in response to a user input text.

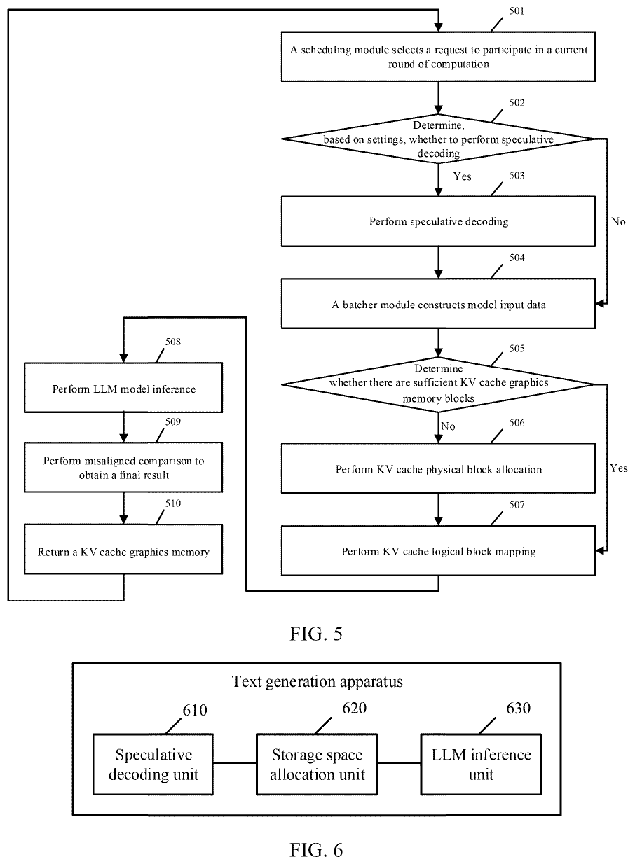

The above-mentioned overall procedure in one round of iteration can be summarized as a flowchart shown in FIG. 5, and includes the following:

Step 501: The scheduling module selects a request to participate in a current round of computation.

Step 502: Determine, based on settings, whether to perform speculative decoding. If yes, step 503 is performed. Otherwise, step 504 is performed.

Step 503: Perform speculative decoding.

Step 504: The batcher module constructs model input data.

Step 505: Determine whether there are sufficient KV cache graphics memory blocks. If no, step 506 is performed. If yes, step 507 is performed.

Step 506: Perform KV cache physical block allocation.

Step 507: Perform KV cache logical block mapping.

Step 508: Perform LLM model inference.

Step 508: Perform misaligned comparison to obtain a final result.

Step 509: Return a KV cache graphics memory.

For a specific method for performing the steps shown in FIG. 5, references can be made to the above-mentioned descriptions. Details are omitted here for simplicity.

Corresponding to the above-mentioned method embodiments, this specification further provides an apparatus and embodiments of a computer device to which the apparatus is applied.

FIG. 6 is a block diagram illustrating a text generation apparatus, according to some example embodiments of this specification. The apparatus is applied to an LLM, and generates an output text for an input text by performing a plurality of rounds of iteration, where at least one round of iteration is performed by the following units: a speculative decoding unit 610, configured to estimate a first text sequence following an obtained current text sequence based on a speculative decoding method, and form a plurality of candidate sequences based on the current text sequence and different subsequences of the first text sequence; a storage space allocation unit 620, configured to allocate logical blocks to text units in the plurality of candidate sequences in a key-value cache, to store attention information of the text units, and map the allocated logical blocks to physical blocks based on a first criterion, where the first criterion includes that a plurality of logical blocks allocated to the same text unit in the plurality of candidate sequences are mapped to the same physical block; and an LLM inference unit 630, used by the LLM to determine a newly generated text unit in the current round of iteration by using attention information of each candidate sequence in the key-value cache, to form a current text sequence for a next round.

In some optional implementations, logical storage space corresponding to the key-value cache forms a matrix, and a logical block in one row in the matrix is used to store a text unit in one candidate sequence; and the storage space allocation unit 620 is specifically configured to add a new row to the matrix for each candidate sequence, and add a logical block to the row for a text unit in the candidate sequence.

In some optional implementations, the speculative decoding unit 610 is specifically configured to query a vocab table by using the current text sequence, to obtain the matching first text sequence, where the vocab table includes a plurality of mapping relationships, the mapping relationship is a mapping relationship between a text sequence and a continuation text sequence following the text sequence, and the vocab table is obtained based on a text generated by the LLM.

In some optional implementations, the vocab table includes a global vocab table and a local vocab table; the global vocab table records a mapping relationship in which a co-occurrence frequency of sequences in the text generated by the LLM is greater than a first frequency threshold; the local vocab table records a mapping relationship in which a co-occurrence frequency of sequences in a text generated for the input text is greater than a second frequency threshold; and after the output text is generated, the local vocab table is added to the global vocab table.

In some optional implementations, the mapping relationship in the vocab table corresponds to a score value determined based on a co-occurrence frequency; and the speculative decoding unit 610 is specifically configured to perform query and matching for the current text sequence in the vocab table; and when there are a plurality of matching text sequences in the vocab table, determine a text sequence with a highest score value as the first text sequence.

In some optional implementations, the LLM inference unit 630 is specifically used by the LLM to predict a next text unit for each candidate sequence by using the attention information of each candidate sequence in the key-value cache, and sequentially form a second text sequence for next text units respectively predicted for the plurality of candidate sequences; and compare the second text sequence with the first text sequence, and determine the newly generated text unit based on a comparison result.

In some optional implementations, the apparatus further includes an incorrect text unit determining unit (not shown in the figure), which is specifically configured to determine a first incorrect text unit based on the comparison result, where the first incorrect text unit is a text unit that exists in the first text sequence and does not exist at a corresponding location in the second text sequence; determine a text unit following the first incorrect text unit in the first text sequence as a second incorrect text unit; and for each incorrect text unit in the first incorrect text unit and the second incorrect text unit, return a logical block and a physical block corresponding to attention information of the incorrect text unit in the key-value cache.

In some optional implementations, the input text includes a plurality of user request texts, the current text sequence includes several sequence segments, and a single sequence segment corresponds to an output text generated for a single user request text; and the first text sequence includes several continuation sequences respectively estimated for the several sequence segments.

In some optional implementations, the apparatus further includes a length determining unit (not shown in the figure), which is specifically configured to determine a hardware computing power indicator and a first quantity of text units in a target request text, where the hardware computing power indicator is used to represent a maximum quantity of text units whose attention information can be simultaneously computed, and the target request text is a user request text for which a first text unit in an output text is not generated when the current round of iteration starts; determine an available computing power indicator based on a difference between the maximum quantity of text units and the first quantity; and determine a length of the first text sequence based on the available computing power indicator.

In some optional implementations, the speculative decoding unit 610 is specifically configured to perform the speculative decoding only when the LLM generates at least one output text unit for each of the plurality of user request texts, where the current text sequence includes a plurality of sequence segments corresponding to the plurality of user request texts.

For an implementation process of functions and roles of each unit in the apparatus, references can be made to an implementation process of corresponding steps in the above-mentioned method. Details are omitted here for simplicity.

Because the apparatus embodiments correspond to the method embodiments, for related parts, references can be made to related descriptions in the method embodiments. The apparatus embodiments described above are merely examples. The units described as separate parts can or cannot be physically separate, and parts displayed as units can or cannot be physical units, can be located at one location, or can be distributed on a plurality of network units. Some or all of the units can be selected based on actual needs to achieve the objectives of the solutions of this specification. A person of ordinary skill in the art can understand and implement the solutions without creative efforts.

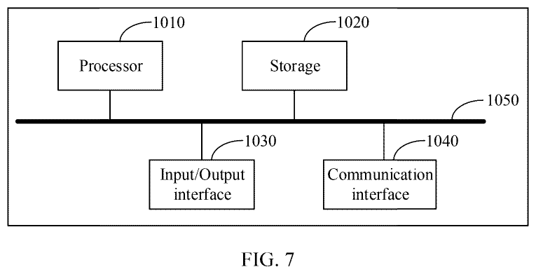

FIG. 7 is a diagram illustrating a hardware structure of a computer device in which a text generation apparatus is located, according to some embodiments. The device can include a processor 1010, a storage 1020 configured to store instructions executable by the processor, an input/output interface 1030, a communication interface 1040, and a bus 1050. The processor 1010, the storage 1020, the input/output interface 1030, and the communication interface 1040 are communicatively connected to each other within the device by using the bus 1050. The processor runs the executable instructions to implement the above-mentioned text generation method.

The processor 1010 can be implemented in a form of a general-purpose central processing unit (CPU), a microprocessor, an application-specific integrated circuit (ASIC), one or more integrated circuits, etc., and is configured to execute a related program, to implement the technical solutions provided in the embodiments of this specification. The processor runs the executable instructions to implement the above-mentioned method.

The storage 1020 configured to store instructions executable by the processor can be implemented in a form of a read-only memory (ROM), a random access memory (RAM), a static storage device, a dynamic storage device, etc. The storage 1020 can store an operating system and other application programs. When the technical solutions provided in the embodiments of this specification are implemented by software or firmware, related program code is stored in the storage 1020.

The input/output interface 1030 is configured to be connected to an input/output module, to implement information input and output. The input/output module can be configured as a component in the device (not shown in the figure), or can be externally connected to the device to provide a corresponding function. An input device can include a keyboard, a mouse, a touchscreen, a microphone, various sensors, etc., and an output device can include a display, a speaker, a vibrator, an indicator light, etc.

The communication interface 1040 is configured to be connected to a communication module (not shown in the figure) to implement communication and interaction between the device and other devices. The communication module can implement communication through a wired method (for example, a USB or a network cable), or through a wireless method (for example, a mobile network, Wi-Fi, or Bluetooth).

The bus 1050 includes a channel to transmit information between various components (for example, the processor 1010, the storage 1020, the input/output interface 1030, and the communication interface 1040) of the device.

It is worthwhile to note that although only the processor 1010, the storage 1020, the input/output interface 1030, the communication interface 1040, and the bus 1050 are shown in the device, in an actual implementation process, the device can further include other components that are necessary for normal running. In addition, a person skilled in the art can understand that the device can include only components that are necessary for implementing the solutions in the embodiments of this specification, and does not necessarily include all the components shown in the figure.

An embodiment of this specification further provide a computer-readable storage medium. The computer-readable storage medium stores a computer program, and when the program is executed by a processor, the above-mentioned text generation method is implemented.

The computer-readable medium includes persistent, non-persistent, removable and non-removable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be configured to store information that can be accessed by a computing device. As described in this specification, the computer-readable medium does not include computer-readable transitory media (transitory media) such as a modulated data signal and a carrier.

It is worthwhile to further note that the terms “include”, “comprise”, or any other variants thereof are intended to cover a non-exclusive inclusion, so that a process, a method, a product, or a device that includes a list of elements not only includes those elements but also includes other elements which are not expressly listed, or further includes elements inherent to such a process, method, product, or device. Without more constraints, an element preceded by “includes a . . . ” does not preclude the presence of additional identical elements in the process, method, product, or device that includes the element.

Specific embodiments of this specification are described above. Other embodiments fall within the scope of the appended claims. In some cases, the actions or steps described in the claims can be performed in a sequence different from that in the embodiments and desired results can still be achieved. In addition, the process depicted in the accompanying drawings does not necessarily need a particular order or consecutive order to achieve the desired results. In some implementations, multi-tasking and parallel processing are feasible or may be advantageous.

User information (including but not limited to user equipment information, personal user information, etc.) and data (including but not limited to data used for analysis, stored data, displayed data, etc.) in this application are information and data that are authorized by a user or that are fully authorized by each party. Furthermore, related data need to be collected, used, and processed in compliance with relevant laws, regulations and standards of relevant countries and regions, and corresponding operation entries are provided for the user to choose to authorize or reject.

This specification further provides a computer program product. When the computer program product is executed by a processor, the above-mentioned text generation method is implemented.

1. A method for generating an output text for an input text based on performing a plurality of iterations, the method comprising:
in an iteration of the plurality of iterations under a large language model (LLM):
estimating a first text sequence following a current text sequence based on a speculative decoding method;
forming a plurality of candidate sequences based on the current text sequence and subsequences of the first text sequence;
allocating logical blocks to text units in the plurality of candidate sequences in a key-value cache, to store attention information of the text units;
mapping the allocated logical blocks to physical blocks based on a first criterion, wherein the first criterion comprises a plurality of logical blocks allocated to a same text unit in the plurality of candidate sequences are mapped to a same physical block; and
determining, by the LLM, a newly generated text unit in the iteration by using attention information of each candidate sequence in the key-value cache, to form a current text sequence for a next iteration of the plurality of iterations.

2. The method according to claim 1, wherein logical storage spaces corresponding to the key-value cache forms a matrix, and a logical block in a row in the matrix stores a text unit in a candidate sequence; and
the allocating logical blocks to text units in the plurality of candidate sequences comprises:
adding a new row to the matrix for each candidate sequence; and
adding a logical block to the row for a text unit in the candidate sequence.

3. The method according to claim 1, wherein the estimating a first text sequence following a current text sequence based on a speculative decoding method comprises:
querying a vocab table by using the current text sequence, to obtain the matching first text sequence, wherein the vocab table comprises a plurality of mapping relationships, each of the mapping relationships is between a text sequence and a continuation text sequence following the text sequence, and the vocab table is obtained based on a text generated by the LLM.

4. The method according to claim 3, wherein the vocab table comprises a global vocab table and a local vocab table, the global vocab table records a mapping relationship in which a co-occurrence frequency of sequences in the text generated by the LLM is greater than a first frequency threshold, the local vocab table records a mapping relationship in which a co-occurrence frequency of sequences in a text generated for the input text is greater than a second frequency threshold, and the local vocab table is added to the global vocab table after the output text is generated.

5. The method according to claim 3, wherein the mapping relationship in the vocab table corresponds to a score value determined based on a co-occurrence frequency; and
the querying a vocab table by using the current text sequence, to obtain the matching first text sequence comprises:
performing query and matching for the current text sequence in the vocab table; and
when the vocab table comprises a plurality of matching text sequences, determining a text sequence with a highest score value as the first text sequence.

6. The method according to claim 1, wherein the determining a newly generated text unit in the iteration comprises:
predicting, by the LLM, a next text unit for each candidate sequence by using the attention information of each candidate sequence in the key-value cache;
sequentially forming a second text sequence for next text units respectively predicted for the plurality of candidate sequences;
comparing the second text sequence with the first text sequence; and
determining the newly generated text unit based on a comparison result.

7. The method according to claim 6, further comprising:
determining a first incorrect text unit based on the comparison result, wherein the first incorrect text unit exists in the first text sequence and does not exist at a corresponding location in the second text sequence;
determining a text unit following the first incorrect text unit in the first text sequence as a second incorrect text unit; and
for each incorrect text unit in the first incorrect text unit and the second incorrect text unit, returning a logical block and a physical block corresponding to attention information of the incorrect text unit in the key-value cache.

8. The method according to claim 1, wherein the input text comprises a plurality of user request texts, the current text sequence comprises a plurality of sequence segments, a single sequence segment corresponds to an output text generated for a single user request text, and the first text sequence comprises a plurality of continuation sequences respectively estimated for the plurality of sequence segments.

9. The method according to claim 8, wherein
before the estimating a first text sequence following a current text sequence based on a speculative decoding method, the method further comprises:
determining a hardware computing power indicator and a first quantity of text units in a target request text, wherein the hardware computing power indicator indicates a maximum quantity of text units whose attention information can be simultaneously computed, and the target request text is a user request text for which a first text unit in an output text is not generated when the iteration starts;
determining an available computing power indicator based on a difference between the maximum quantity of text units and the first quantity; and
determining a length of the first text sequence based on the available computing power indicator.

10. The method according to claim 8, wherein the estimating a first text sequence following a current text sequence based on a speculative decoding method comprises:
performing the speculative decoding when the LLM generates at least one output text unit for each of the plurality of user request texts, wherein the current text sequence comprises a plurality of sequence segments corresponding to the plurality of user request texts.

11. An apparatus for generating an output text for an input text based on performing a plurality of iterations, the apparatus comprising:
at least one processor; and
one or more memories coupled to the at least one processor and storing programming instructions for execution by the at least one processor to perform operations comprising:
in an iteration of the plurality of iterations under a large language model (LLM):
estimating a first text sequence following a current text sequence based on a speculative decoding method;
forming a plurality of candidate sequences based on the current text sequence and subsequences of the first text sequence;
allocating logical blocks to text units in the plurality of candidate sequences in a key-value cache, to store attention information of the text units;
mapping the allocated logical blocks to physical blocks based on a first criterion, wherein the first criterion comprises a plurality of logical blocks allocated to a same text unit in the plurality of candidate sequences are mapped to a same physical block; and
determining, by the LLM, a newly generated text unit in the iteration by using attention information of each candidate sequence in the key-value cache, to form a current text sequence for a next iteration of the plurality of iterations.

12. The apparatus according to claim 11, wherein logical storage spaces corresponding to the key-value cache forms a matrix, and a logical block in a row in the matrix stores a text unit in a candidate sequence; and
the allocating logical blocks to text units in the plurality of candidate sequences comprises:
adding a new row to the matrix for each candidate sequence; and
adding a logical block to the row for a text unit in the candidate sequence.

13. The apparatus according to claim 11, wherein the estimating a first text sequence following a current text sequence based on a speculative decoding method comprises:
querying a vocab table by using the current text sequence, to obtain the matching first text sequence, wherein the vocab table comprises a plurality of mapping relationships, each of the mapping relationships is between a text sequence and a continuation text sequence following the text sequence, and the vocab table is obtained based on a text generated by the LLM.

14. The apparatus according to claim 13, wherein the vocab table comprises a global vocab table and a local vocab table, the global vocab table records a mapping relationship in which a co-occurrence frequency of sequences in the text generated by the LLM is greater than a first frequency threshold, the local vocab table records a mapping relationship in which a co-occurrence frequency of sequences in a text generated for the input text is greater than a second frequency threshold, and the local vocab table is added to the global vocab table after the output text is generated.

15. The apparatus according to claim 13, wherein the mapping relationship in the vocab table corresponds to a score value determined based on a co-occurrence frequency; and
the querying a vocab table by using the current text sequence, to obtain the matching first text sequence comprises:
performing query and matching for the current text sequence in the vocab table; and
when the vocab table comprises a plurality of matching text sequences, determining a text sequence with a highest score value as the first text sequence.

16. The apparatus according to claim 11, wherein the determining a newly generated text unit in the iteration comprises:
predicting, by the LLM, a next text unit for each candidate sequence by using the attention information of each candidate sequence in the key-value cache;
sequentially forming a second text sequence for next text units respectively predicted for the plurality of candidate sequences;
comparing the second text sequence with the first text sequence; and
determining the newly generated text unit based on a comparison result.

17. The apparatus according to claim 16, the operations further comprising:
determining a first incorrect text unit based on the comparison result, wherein the first incorrect text unit exists in the first text sequence and does not exist at a corresponding location in the second text sequence;
determining a text unit following the first incorrect text unit in the first text sequence as a second incorrect text unit; and
for each incorrect text unit in the first incorrect text unit and the second incorrect text unit, returning a logical block and a physical block corresponding to attention information of the incorrect text unit in the key-value cache.

18. The apparatus according to claim 11, wherein the input text comprises a plurality of user request texts, the current text sequence comprises a plurality of sequence segments, a single sequence segment corresponds to an output text generated for a single user request text, and the first text sequence comprises a plurality of continuation sequences respectively estimated for the plurality of sequence segments.

19. The apparatus according to claim 18, wherein
before the estimating a first text sequence following a current text sequence based on a speculative decoding method, the method further comprises:
determining a hardware computing power indicator and a first quantity of text units in a target request text, wherein the hardware computing power indicator indicates a maximum quantity of text units whose attention information can be simultaneously computed, and the target request text is a user request text for which a first text unit in an output text is not generated when the iteration starts;
determining an available computing power indicator based on a difference between the maximum quantity of text units and the first quantity; and
determining a length of the first text sequence based on the available computing power indicator.

20. A non-transitory, computer-readable medium storing one or more instructions executable by at least one processor to perform operations comprising:
in an iteration of a plurality of iterations under a large language model (LLM):
estimating a first text sequence following a current text sequence based on a speculative decoding method;
forming a plurality of candidate sequences based on the current text sequence and subsequences of the first text sequence;
allocating logical blocks to text units in the plurality of candidate sequences in a key-value cache, to store attention information of the text units;
mapping the allocated logical blocks to physical blocks based on a first criterion, wherein the first criterion comprises a plurality of logical blocks allocated to a same text unit in the plurality of candidate sequences are mapped to a same physical block; and
determining, by the LLM, a newly generated text unit in the iteration by using attention information of each candidate sequence in the key-value cache, to form a current text sequence for a next iteration of the plurality of iterations.
